(19) United States
(12) Patent Application Publication
(10) Pub. No.: US 2014/0071395 A1
(43) Pub. Date: Mar. 13, 2014

(54) EYEGLASSES WITH RAISABLE LENSES

(71) Applicant: REBECCA BURROUGHS, Creve Coeur, IL (US)

(72) Inventor: REBECCA BURROUGHS, Creve Coeur, IL (US)

(21) Appl. No.: 14/020,825

(22) Filed: Sep. 7, 2013

Related U.S. Application Data
(60) Provisional application No. 61/697,877, filed on Sep. 7, 2012.

(51) Int. Cl. G02C 5/00

(52) U.S. Cl. CPC G02C 5/005
USPC 351/59

(57) ABSTRACT

The invention provides eyeglasses with lenses that can be placed in front of the eye to correct vision or raised above the eyes to provide access to one or both eyes and face. Each lens can be independently positioned in front of the eye or above the eye allowing clear vision in one eye and access to the other eye and side of face for activities such as make-up application, eye drop application or insertion or removal of contact lenses.

### CROSS-REFERENCE TO RELATED APPLICATIONS

This application claims priority to U.S. provisional application Ser. No. 61/697,877, filed Sep. 7, 2012, the contents of which is incorporated herein by reference in its entirety.

### BACKGROUND

For individuals with impaired vision, activities such as applying make-up to the eye or inserting or removing contact lenses can be challenging because the eyeglasses needed for clear vision often impede access to the eye and surrounding area of the face.

### SUMMARY

The invention provides eyeglasses having lenses attached to temple arms, each of which can be independently raised above the eye. As such, the eyeglasses of the invention can provide corrected vision in one eye and unhindered access to the other eye and side of face.

In one embodiment, the invention provides eyeglasses having (a) a pair of lenses, (b) a nosebridge connecting the pair of lenses, the nosebridge comprising of two detachable components that when attached together, form a nosebridge connecting the lenses, and when detached, physically separate the lenses one from the other, (c) a pair of temple arms, each of which is attached to the outer edge of each of the lenses, and (d) a headband to which the temple arms are rotatably secured, the headband being effective to engage at least a portion of the wearer's head thereby holding the eyeglasses in place.

In some embodiments, the lenses are mounted in a frame comprising the nosebridge. In some embodiments, the nosebridge components are held together by magnetic forces. In some embodiments, the nosebridge components are held together by a snap mechanism. In some embodiments, one component of the nosebridge includes a groove within which the other component of the nosebridge occupies to form the nosebridge. In some embodiments, the temple arms comprise a longitudinal slot for securing the temple arms to the headband at various positions along the temple arms. In some embodiment, the temple arms are secured to the headband using a screw and nut, e.g. wing nut.

In some embodiments, the temple arms comprise two overlapping units assembled in a telescopic design thereby allowing the length of the temple arms to be adjusted by the wearer.

In some embodiments, the headband wraps around the back of the wearer's head from ear to ear enabling one or both lenses to be positioned before the eyes to correct vision or raised above the eye for access to one or both eyes or sides of face. In some embodiments, the headband is effective to fit around the back or over the top of the wearer's head enabling one or both lenses to be positioned before the eyes to correct vision or raised above the eye for access to one or both eyes or sides of the face. In some embodiments, the headband is effective to fit around the circumference of the wearer's head. In some embodiments, the lenses are corrective lenses for far-sighted eyes.

Thus, in one embodiment, the invention provides eyeglasses having slideable temple arms attached to the sides of a headband that is worn around the back of the head. The temple arms can be constructed to allow one or both lenses to be positioned in front of the eyes, to move in and out from the eyes, or to be raised above the eyes for access to one or both eyes or sides of face. A slotted temple arm and decorative wing nut can be used to this end. The temple arms can be worn one side up and one side down to assist the vision-impaired in activities such as, for example, make-up application, eye drop application, contact lens insertion and removal, false eye lash application, use of a microscope or shooting a rifle, shot gun or pistol. The eyeglasses of the invention are useful where one eye requires corrective lens, while unobstructed access to the other eye is helpful. Both temple arms and lenses may also be raised when no corrective lenses are needed or both lowered in front of the eyes for reading. A small bridge can be used to support the lowered lenses in front of the eye, while decorative wing nut can be used to secure the temple arms in a desired position.

The design of the eyeglasses of the invention is useful for far-sighted and presbyopic eyes, as they provide corrected vision in one eye and unhindered access to the whole other side of the face. As such, brow definition, eyeliner, eye shadow and mascara can be applied without lens, frame or other hindrances.

Any feature or combination of features described herein are included within the scope of the present invention provided that the features included in any such combination are not mutually inconsistent as will be apparent from the context, this specification and the knowledge of one of ordinary skill in the art.

Unless otherwise defined, all technical and scientific terms used herein have the same meaning as commonly understood by one of ordinary skill in the art to which this invention belongs. In case of conflict, the present specification, including definitions, will control. In addition, the materials, methods, and examples are illustrative only and not intended to be limiting. Although methods and materials similar or equivalent to those described herein can be used to practice the invention, suitable methods and materials are described below.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

Other features and advantages of the invention will be apparent from the following detailed description and from the claims.

### BRIEF DESCRIPTION OF THE DRAWINGS

FIG. 1 is a front view of a pair of eyeglasses of the present invention in which the left lens is in a raised position.

FIG. 2 is a top perspective view of the pair of eyeglasses shown in FIG. 1.

FIG. 3 is a side view of the pair of eyeglasses shown in FIG. 1.

FIGS. 4A-4D are views of various components of the eyeglasses shown in FIG. 1 including a top view of temple arm 14 adjoining frame 22 on either side of nose bridge 12 (4A); a top, enlarged view of the hinge area where temple arm 14 adjoins frame 22 (4B); and a top, enlarged view of nosebridge 12 illustrating components 12a and 12b that come together to form nose bridge 12 (4C); and a side view of the slotted temple arm 14 attached to frame 22 (4D).

FIGS. 5A-5B are two views of headband 16 including a top perspective view (5A) and a side view (5C) illustrating ends 16a and 16b to which a temple arm of the invention can be rotatably secured.

FIGS. 6A-6B provide a top view of headband 16 and an enlarged view of end 16b illustrating the opening (broken lines) through which a temple arm of the invention can be rotatably secured.

FIGS. 7A-7C are three views of nut 18 that can be used to secure a temple arm of the invention to a headband including a bottom perspective view (7A), a side view (7B) and a bottom view (7C), which illustrates threaded opening 26 (formed by wall 26w having threads 26t) through which a screw can be inserted.

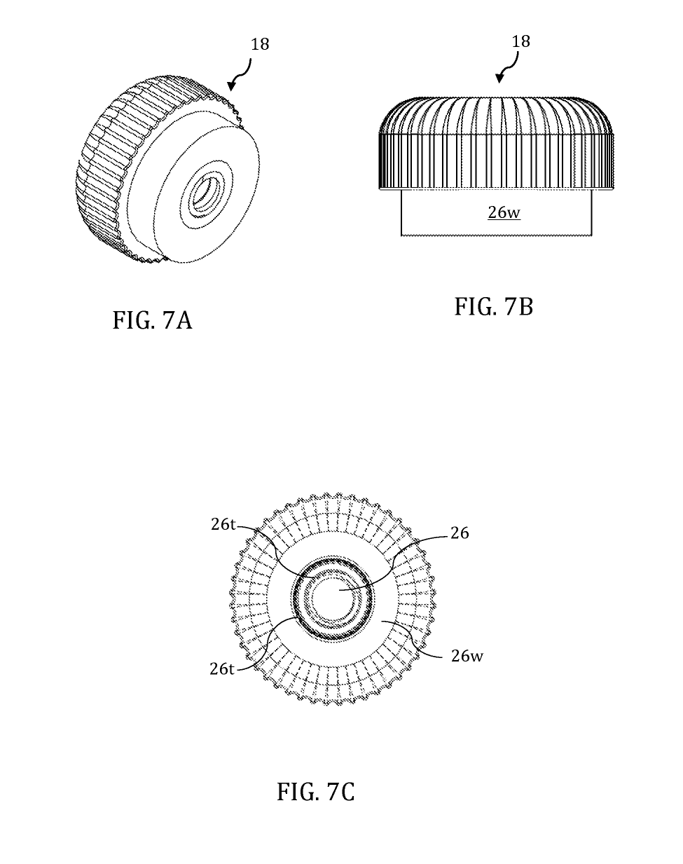

FIGS. 8A-8B are front perspective views of a person wearing a pair of eyeglasses of the invention where the headband is worn around the back of the head (8A), or over the top of the head (8B), and the right lens is raised above the eye enabling access to the right eye and side of face and the head.

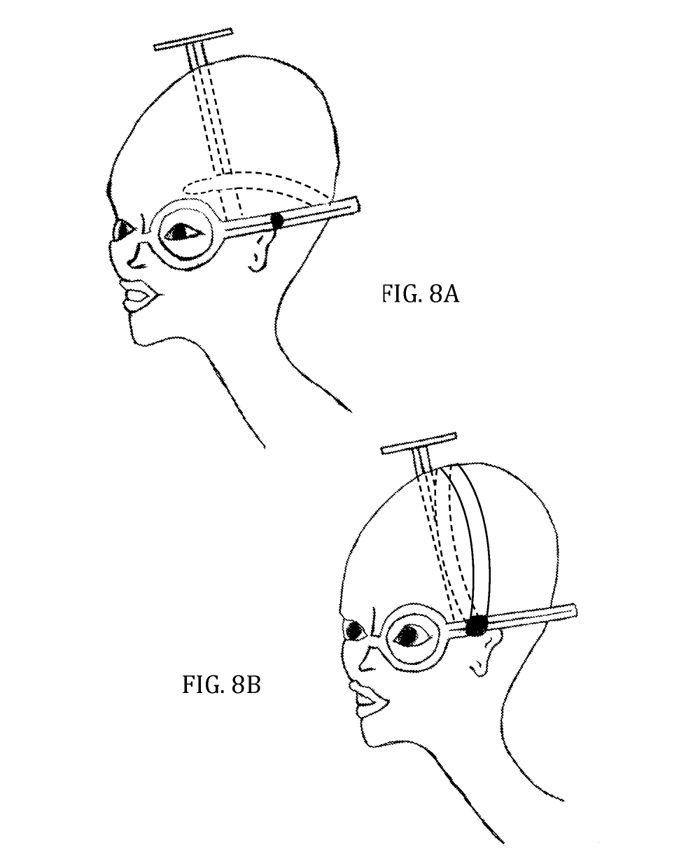

### DETAILED DESCRIPTION

The invention provides eyeglasses having lenses attached to temple arms, each of which can be raised independently above the eye. As such, the eyeglasses of the invention can provide corrected vision in one eye and unhindered access to the other eye and side of face.

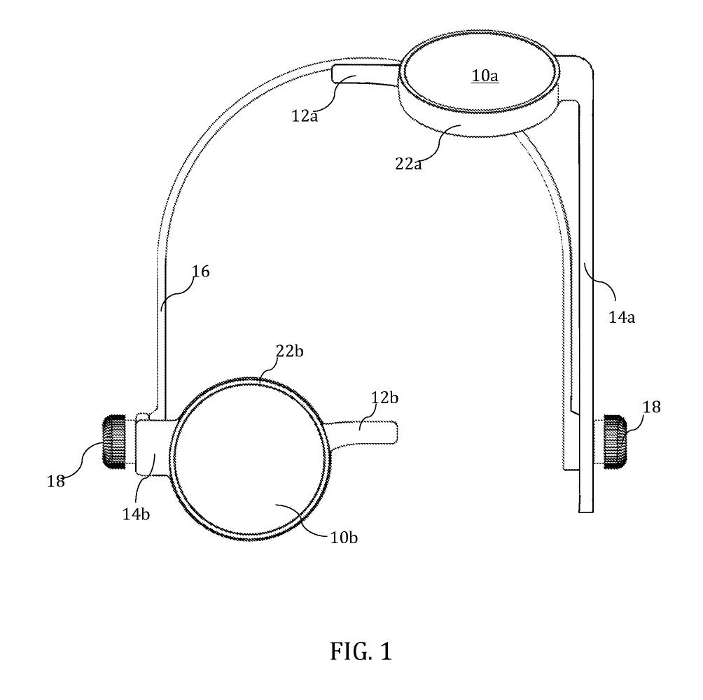

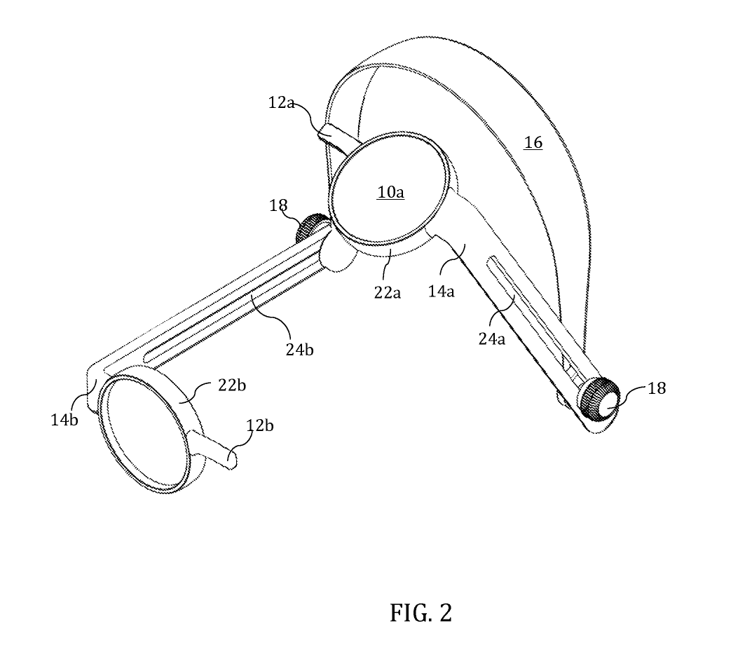

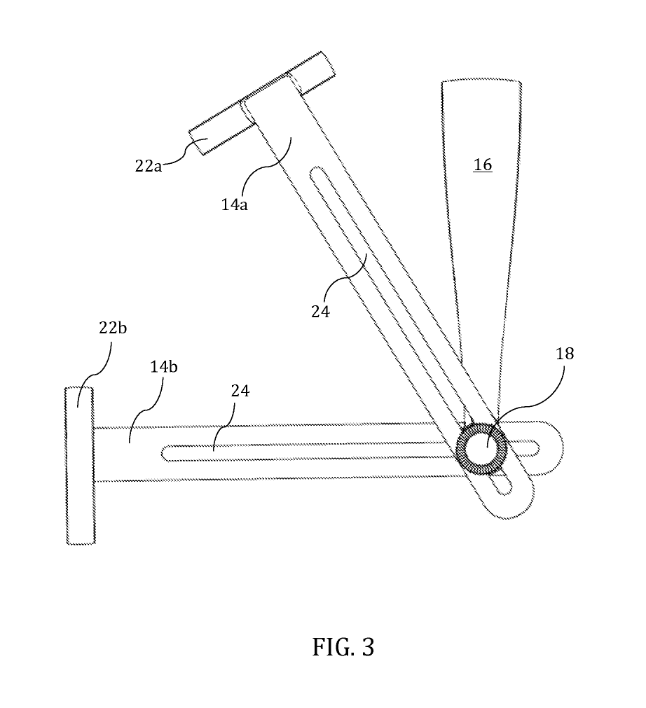

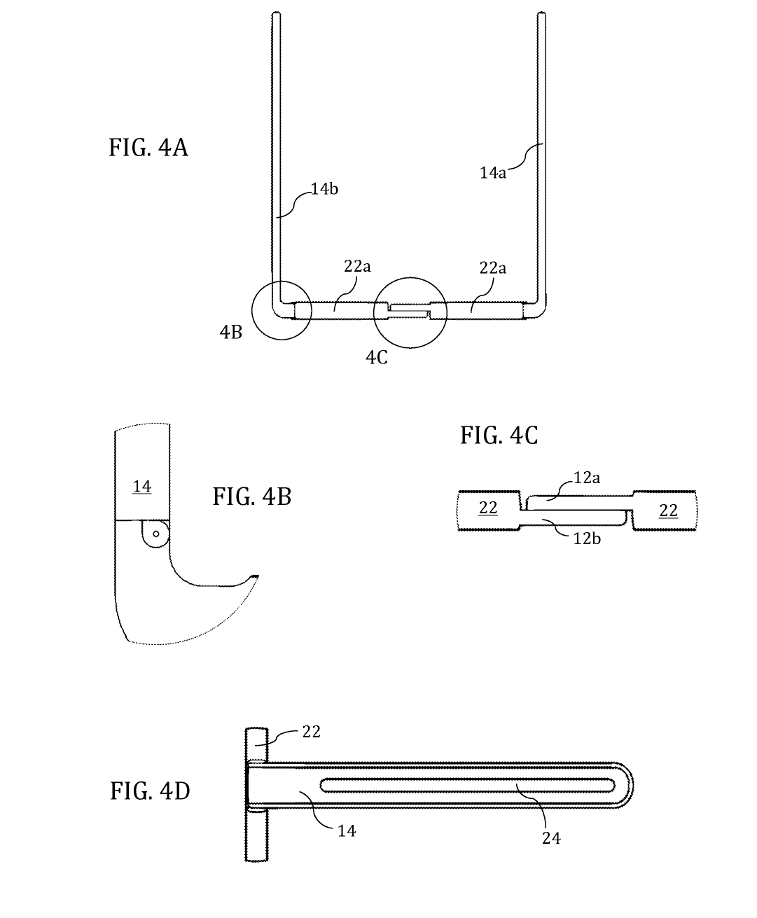

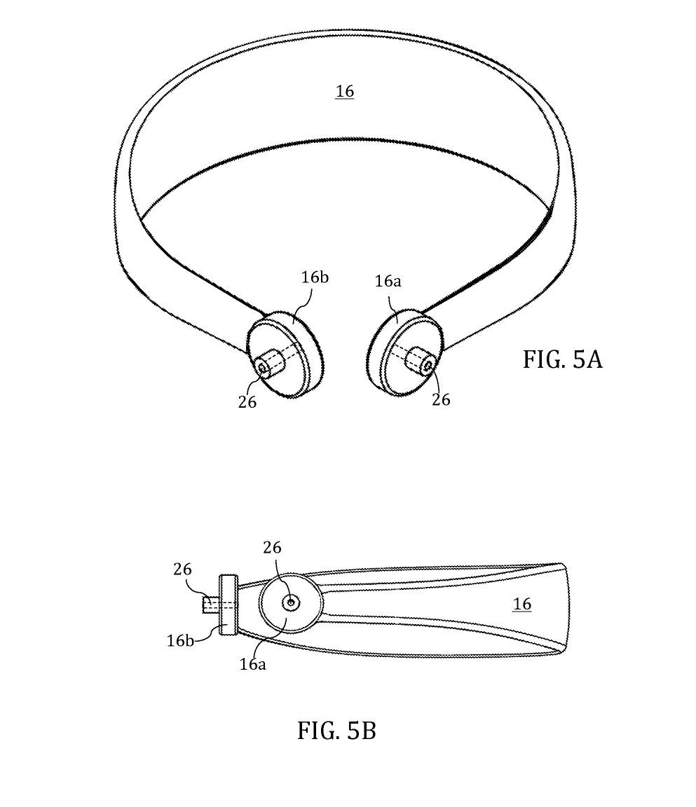

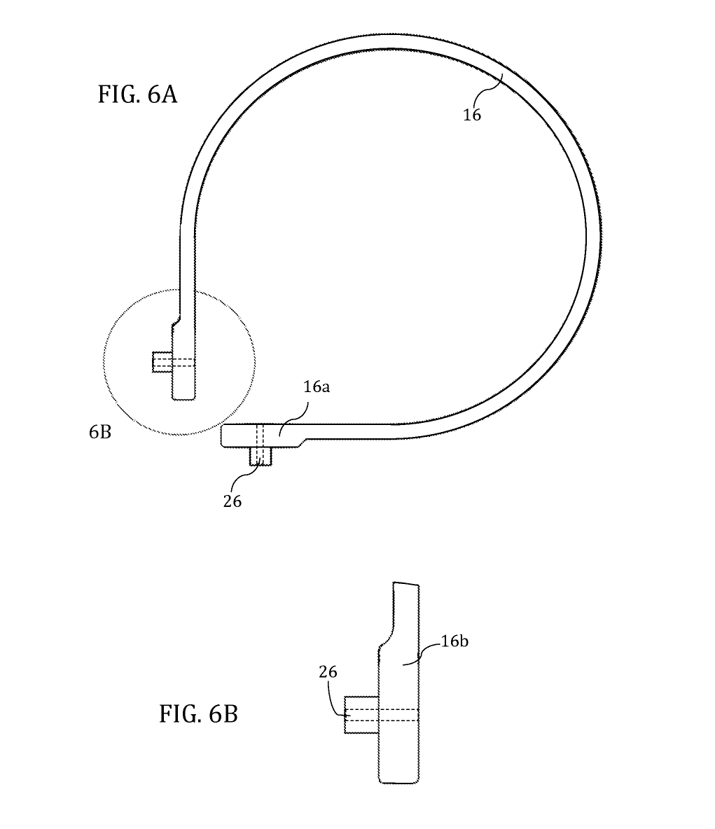

An embodiment of a pair of eyeglasses of the invention is shown in FIG. 1. Lenses 10a and 10b are mounted in frame 22 having nosebridge 12. Lenses 10a and 10b can be separated one from the other at nosebridge 12 as shown in FIG. 2. The attached temple arm 14b is shown mounted to headband 16 using wing nut 18. Temple arm 14a or 14b has longitudinal slot 24a or 24b, respectively, that allow for a more custom fit of the eyeglasses by enabling the wearer to adjust the effective length of the temple arm by selecting the position along the temple arm at which it is secured to the headband 16. When secured with a screw and wing nut to headband 16, temple arm 14a or 14b can be rotated to a verticle position so that each lens can be independently raised as shown in FIG. 3 and FIG. 4. Headband 16 wraps around the back of the wearer's head as shown in FIG. 5 thereby holding the eyeglasses in place. In FIG. 5, raised lens 10a leaves the right eye and side of face 20 open and accessible, while lens 10b enables the wearer to see clearly through the left eye. FIGS. 6A and B illustrates a temple arm having longitudinal slot 24 that allows the temple arm to be secured to headband 16 at various positions along the length of the temple arm using screw and wing nut 18.

The eyeglasses of the invention can be constructed to include a frame into which the lenses are mounted as shown in the figures. Alternatively, eyeglasses of the invention can be constructed without a frame, in which case, the lenses can be directly attached to a nosebridge at their inner edges and to the temple arms at the outer side edges using any means known to those of skill in the art. For example, in the absence of frame 22, lenses 10a and 10b can be joined to each other using a nosebridge that directly attaches to the inner edge of the lenses. Similarly, in the absence of frame 22, lenses 10a and 10b can be directly attached to temple arms 14a and 14b at their side edges using any means as known to those of skill in the art.

Whether with or without a frame, the nosebridge can be constructed in any manner known to those of skill in the art so as to enable the lenses to be conveniently brought together in a position similar to that in FIG. 1 or separated one from the other in a position similar to that shown in FIG. 2. For example, the nosebridge can be composed of two components attachable to each other through magnetic forces. Alternatively, the two components of the nosebridge can be constructed so as to enable the pieces to be snapped together or released from each other by applying a light physical force. The nosebridge can also be constructed so that one component forms a groove or slot within which the other component occupies, in doing so, forming a bridge joining the attached lenses together. Any type of connecting mechanism can be used to hold together the two components forming the nosebridge including, for example, latches.

The temple arms attached to the outer sides of the lenses can be constructed to allow for effective length adjustment thereby enabling a better fit. As used herein, the term “effective length” refers to the distance between (1) the position where a temple arm is attached to the lens and (2) the position where the temple arm is secured to the headband. In contrast, the actual length of a temple arm is the end-to-end length. The effective length and the actual length of a temple arm may be, though need not be, the same.

Any means that enables effective length adjustment known to those of skill in the art can be used. For example, the temple arm can be constructed of two sliding overlapping units functioning as a telescopic mechanism thus allowing for effective length adjustment. The temple arm can be a single unit with a longitudinal slot that allows the arm to be secured to the headband at various positions along the length of the temple arm using a screw and nut thereby allow for effective length adjustment. The temple arms can be secured to the headband using any means known to those of skill in the art including, for example, a cinch, a screw, a nut, a wing nut, buckle, snaps or any combination thereof. The temple arm can be constructed of materials sufficiently rigid to maintain the lens in a desired position as shown in the figures.

Any manner for securing the temple arms to the headband can be used so long as the temple arms can be rotated to a vertical orientation to lift the lens away from the eye. For example, the temple arms can be rotatably secured to a headband, or it can be secured to a rotatable segment of a headband. Any mechanism for achieving rotation known to those of skill in the art can be used to practice the invention including, for example, one that enables the temple arms to snap into a vertical or horizontal position. The figures illustrate the use of a decorative wing nut to secure a slotted temple arm in a horizontal or vertical position directly on headband 16. In the embodiments shown in the figures, the effective lengths of the temple arms are also fixed using the same decorative wing nut.

The headband on which the temple arms are mounted engages at least a portion of the wearer's head thereby holding the eyeglasses in place. The headband can be constructed to fit around the circumference of the user's head or to fit across a portion of the user's head so long as it is effective to hold the eyeglasses in place. For example, the headband can be constructed to fit from ear to ear, or temple to temple, around the back of the head, over the top of the head, across the forehead or extending down and across the nape of the neck. The headband can be constructed to apply a uniform force all around points of contact with the head, or constructed to achieve nonuniform force such as, for example, a stronger grip at the temples, sides of the head, or near the ears. It can be constructed of any material that has sufficient strength and flexibility to maintain a secure but comfortable grip of the user's head thereby ensuring the eyeglasses are securely positioned on the user. The headband can be constructed of rigid but flexible, or expandible and contractile, material so as to fit a variety of head sizes. The headband can have any dimension or shape so long as it can be securely placed on the head to hold the lenses in position before the eyes for enhanced vision or above the eyes for access to one or both eyes and sides of the face.

Thus, in one embodiment, the eyeglasses can be for far-sighted and presbyopic eyes, providing corrected vision in one eye and unhindered access to the whole other side of the face. When employed as make-up glasses, for example, brow definition, eyeliner, eye shadow and mascara application can be performed without the need to work around lens, frame or any other hindrances. The eyeglasses can have slideable temple arms attached to the side of a headband, which can be worn around the back of the head. The slideable temple arms can include a longitudinal slot allowing it to be secured to the headband using a slideable and decorative wing nut, for example, thereby enabling the user to adjust or control the length and position of the temple arms on the user. For example, the temple arms can be moved in and out from the eye, as well as up and down, thereby allowing the attached lens to move in and out relative to the eye, as well as raised up above the eye or lowered down in front of the eye. The temple arms can be worn one side up and one side down during various activities such as, without limitation, make-up application, eye drop insertion, contact lens insertion and removal, and false eye lash application. Thus, the eyeglasses can be used when one eye needs a corrective lens and one eye need to be free of any obstruction. Both of the temple arms may be raised when no corrective lens is needed, or both may be lowered in front of the eyes for reading. When positioned in the desired place, the temple arms can be secured with a decorative wing nut, and small bridge supports the lowered lens in front of the eye. The following summarizes the components in an embodiment of the invention.

| COMPONENTS | REF. NO. | COMPONENT | REF. NO. |
|---|---|---|---|
| Lens | 10 | 10a (left) | 10b (right) |
| Nosebridge | 12 | 12a (left) | 12b (right) |
| Temple arm | 14 | 14a (left) | 14b (right) |
| Headband | 16 | 16a (left end) | 16b (right end) |
| Nut | 18 | | |
| Frame | 22 | 22a (right) | 22b (left) |
| Temple arm slot | 24 | 24a (left) | 24b (right) |
| Headband end opening | 26 | 26w (wall) | 26t (threads) |

The specific embodiments of the invention described above do not limit the scope of the invention described in the claims.

### OTHER EMBODIMENTS OF THE INVENTION

Varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Under no circumstances may the patent application be interpreted to be limited to the specific examples or embodiments or methods specifically disclosed herein. As used herein and in the appended claims, the singular forms “a,” “an,” and “the” include plural reference, and vice versa, unless the context clearly dictates otherwise. The invention has been described broadly and generically herein. Each of the narrower species and subgeneric groupings falling within the generic disclosure also form part of the invention.

What is claimed is:

1. Eyeglasses comprising:
(a) a pair of lenses,
(b) a nosebridge connecting the pair of lenses, the nosebridge comprising of two detachable components that when attached together, form a nosebridge connecting the lenses, and when detached, physically separate the lenses one from the other,
(c) a pair of temple arms, each of which is attached to the outer edge of each of the lenses, and
(d) a headband to which the temple arms are rotatably secured, the headband being effective to engage at least a portion of the wearer's head thereby holding the eyeglasses in place.

2. The eyeglasses of claim 1, wherein the lenses are mounted in a frame comprising the nosebridge.

3. The eyeglasses of claim 2, wherein the nosebridge components are held together by magnetic forces.

4. The eyeglasses of claim 2, wherein the nosebridge components are held together by a snap mechanism.

5. The eyeglasses of claim 4, wherein one component of the nosebridge comprises a groove within which the other component of the nosebridge occupies to form the nosebridge.

6. The eyeglasses of claim 2, wherein the temple arms comprise a longitudinal slot for securing the temple arms to the headband at various positions along the temple arms.

7. The eyeglasses of claim 6, wherein the temple arms are secured to the headband using a screw and nut.

8. The eyeglasses of claim 2, wherein the temple arms comprise two overlapping units assembled in a telescopic design thereby allowing the length of the temple arms to be adjusted by the wearer.

9. The eyeglasses of claim 2, wherein the headband is effective to fit around the back, over the top or around the circumference of the wearer's head enabling one or both lenses to be positioned before the eyes to correct vision or raised above the eye for access to one or both eyes or sides of the face.

10. The eyeglasses of claim 2, wherein the lenses are corrective lenses for far-sighted eyes.

11. The eyeglasses of claim 1, wherein the lenses are directly attached to a nosebridge at their inner edges and to the temple arms at their outer edges.

12. The eyeglasses of claim 1, wherein the nosebridge components are held together by magnetic forces.

13. The eyeglasses of claim 1, wherein the nosebridge components are held together by a snap mechanism.

14. The eyeglasses of claim 1, wherein one component of the nosebridge comprises a groove within which the other component of the nosebridge occupies to form the nosebridge.

15. The eyeglasses of claim 1, wherein the temple arms comprise a longitudinal slot for securing the temple arms to the headband at various positions along the temple arms.

16. The eyeglasses of claim 15, wherein the temple arms are secured to the headband using a screw and nut.

17. The eyeglasses of claim 1, wherein the temple arms comprise two overlapping units assembled in a telescopic design thereby allowing the length of the temple arms to be adjusted by the wearer.

18. The eyeglasses of claim 1, wherein the headband is effective to fit around the back or over the top of the wearer's head enabling one or both lenses to be positioned before the eyes to correct vision or raised above the eye for access to one or both eyes or sides of the face.

19. The eyeglasses of claim 1, wherein the headband is effective to fit around the circumference of the wearer's head.

20. The eyeglasses of claim 1, wherein the lenses are corrective lenses for far-sighted eyes.
